(19) United States
(12) Patent Application Publication
(10) Pub. No.: US 2003/0194359 A1
(43) Pub. Date: Oct. 16, 2003

(54) Combustion heater and fuel processor utilizing ceramic technology

(76) Inventors: Dominic Francis Gervasio, Fountain Hills, AZ (US); Daniel Zindel, Mesa, AZ (US); Sonja Tasic, Gilbert, AZ (US); Stephen P. Rogers, Phoenix, AZ (US); Chowdary Ramesh Koripella, Scottsdale, AZ (US); David L. Wilcox, Chandler, AZ (US); Christopher K. Dyer, Madison, NJ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/121,274

(22) Filed: Apr. 12, 2002

(51) Int. Cl. B01J 8/02; F23D 21/00

(52) U.S. Cl. 422/198; 422/211; 422/222; 422/110

(57) ABSTRACT

A multilayered ceramic chemical combustion heater for use in an integrated fuel reformer including a three-dimensional multilayer fired ceramic carrier structure defining at least one ceramic cavity therein and a method of forming the chemical combustion heater. A catalyst is formed in combination with the at least one cavity, being introduced into the cavity subsequent to the firing of the ceramic structure, thereby defining a closed heating zone. The catalyst provides for complete air oxidation of an input fuel. The chemical combustion heater generates heat in proportion to the feed rate of the input fuel and air. The ceramic cavity further includes a fuel inlet, an air inlet, or a combination pre-mixed fuel/air inlet, and an outlet. Feedback control of the feed rate of the input fuel and air allows for the maintenance of the chemical combustion heater at a specific temperature. The fuel processor includes a monolithic three-dimensional multilayer ceramic carrier structure defining a fuel reformer having heat provided by the integrated chemical combustion heater.

### FIELD OF INVENTION

The present invention pertains to ceramic technology devices, and more particularly to a combustion heater and a fuel processor, fabricated utilizing ceramic technology for improved size and performance benefits.

### BACKGROUND OF THE INVENTION

Fuel cell systems for man-portable electrical power supplies, in general, are “battery replacements”. Like batteries, fuel cells produce electricity through an electrochemical process, more specifically, a fuel cell produces electricity from fuel and air without combustion. The electrochemical process utilized provides for the combining of hydrogen, the fuel, with oxygen from the air. The process is accomplished utilizing an electrolyte, such as a polymer electrolyte membrane (PEM), which conducts ions, such as protons. The PEM is sandwiched between two electrodes, namely an anode, the negative electrode used for hydrogen oxidation, and a cathode, the positive electrode used for oxygen reduction. Fuel cells, as known, can perpetually provide electricity as long as fuel and oxygen are supplied. Hydrogen is typically used as the fuel in fuel cells for producing the electricity and it can be processed from methanol, natural gas, petroleum, ammonia, or stored in metal hydrides, carbon nanotubes, or as pure hydrogen. Reformed hydrogen fuel cells (RHFCs) utilize hydrogen fuel processed from liquid or gaseous hydrocarbon fuels, such as methanol, using a reactor, called a fuel reformer, for converting the fuel into hydrogen.

Reformed hydrogen fuel cells preferably utilize methanol that is reformed into hydrogen as a fuel source. Methanol is the preferred fuel for use in fuel reformers for portable applications because it is easier to reform into hydrogen gas at a relatively low temperature compared to other hydrocarbon fuels such as ethanol, gasoline, or butane. The reforming or converting of methanol into hydrogen usually takes place by one of three different types of reforming. These three types are steam reforming, partial oxidation reforming, and autothermal reforming. Of these types, steam reforming is the preferred process for methanol reforming because it is the easiest to control and produces a higher concentration of hydrogen output by the reformer, at a lower temperature, thus lending itself to favored use.

Fuel reformers have been developed for use in conjunction with fuel cell devices, but they are typically cumbersome and complex systems consisting of several discrete sections connected together with gas plumbing and hardware to produce hydrogen gas, and are thus not suitable for portable power source applications. Recently fuel reformers have been developed utilizing ceramic monolithic structures in which the miniaturization of the reformer can be achieved. Utilizing multilayer laminated ceramic technology, ceramic components and systems are now being developed for use in microfluidic chemical processing and energy management systems. Monolithic structures formed of these laminated ceramic components are inert and stable to chemical reactions and capable of tolerating high temperatures. These structures can also provide for miniaturized components, with a high degree of electrical and electronic circuitry or components embedded or integrated into the ceramic structure for system control and functionality. Additionally, the ceramic materials used to form ceramic components or devices, including microchanneled configurations, are considered to be excellent candidates for catalyst supports and so are extraordinarily compatible for use in microreactor devices for generating hydrogen used in conjunction with miniaturized fuel cells. During steam reforming, raw methanol is catalytically converted, with the application of heat, to a hydrogen enriched fuel gas for use with fuel cells. As previously stated, a common means for converting of methanol into hydrogen takes place by steam reforming. Typically, a steam reformer is endothermically operated at an elevated temperature (180°-300° C.), thereby ensuring the reforming reaction is maintained in its optimal operating temperature. Common means for generating these elevated temperatures has been found using conventional electrical heaters and chemical combustion heaters for large reformer reactors. Conventional electrical heating has been demonstrated in multilayered ceramic methanol steam reformer reactors for miniaturized applications. At this time there exists a desire to further miniaturize and integrate this means of heating to achieve steam reforming and develop a miniature in-situ chemical combustor for portable applications such as elevated temperature fuel cells, microturbines, thermoelectrics, portable chemical reactors, and the like.

Accordingly, it is an object of the present invention to provide for a miniaturized chemical combustion heater that provides for the heating of a reformer system, thereby attaining and maintaining proper temperatures to achieve steam reforming.

It is another object of the present invention to provide for a miniaturized chemical combustion heater that is formed utilizing ceramic technology.

It is another object of the present invention to provide for a miniaturized chemical combustion heater that is formed utilizing ceramic technology, including a combustion catalyst to allow for complete combustion of fuel in air to release stored chemical energy as heat.

It is yet another object of the present invention to provide for a monolithic steam reforming structure including an integrated chemical combustion heater.

It is still another object of the present invention to provide for a monolithic steam reforming structure including a chemical combustion heater that is formed utilizing ceramic technology, thereby providing for the integration of a plurality of internal plumbing interconnections and electrical circuitry and connections.

It is another object of the present invention to provide for a multilayer chemical combustion heater that is miniaturized for use in conjunction with an integrated fuel cell for portable device applications.

### SUMMARY OF THE INVENTION

The above problems and others are at least partially solved and the above purposes and others are realized in a multilayered ceramic chemical combustion heater for use in an integrated fuel reformer including a three-dimensional multilayer ceramic carrier structure defining at least one ceramic cavity having a geometric surface area and a method of fabricating the chemical combustion heater. A catalyst material is formed in combination with the at least one ceramic cavity, being introduced subsequent to the firing of the plurality of ceramic layers, which define the cavity. The catalyst is characterized as providing for complete air oxidation of an input fuel and the generation of heat in proportion to the feed rate of the input fuel and air. The at least one ceramic cavity further includes a fuel inlet, an air inlet, or a single combination fuel/air inlet and an outlet for combustion products as well as any uncombusted fuel and remaining air. Optionally included is at least one temperature sensor. The temperature sensor is provided to permit feedback control of the feed rate of the input fuel and/or air. This feedback control of the feed rate of the input fuel and/or air allows for the maintenance of the heater at a specific temperature and feed rate. Additionally, disclosed is the integration of the chemical combustion heater into a fuel processing system with components such as a reformer and a fuel cell.

### BRIEF DESCRIPTION OF THE DRAWINGS

The novel features believed characteristic of the invention are set forth in the claims. The invention itself, however, as well as other features and advantages thereof will be best understood by reference to detailed descriptions which follow, when read in conjunction with the accompanying drawings, wherein:

FIG. 1 is a simplified sectional view of a first embodiment of a chemical combustion heater, according to the present invention;

FIG. 2 is a simplified sectional view taken along line 2-2 of FIG. 1;

FIGS. 3-11 are simplified sectionals view of additional embodiments of a chemical combustion heater, according to the present invention;

FIG. 12 is a simplified sectional view of a fuel processor including a chemical combustion heater, a reactor for reforming methanol to hydrogen and integrated fuel cell stack according to the present invention; and

FIG. 13 is a schematic diagram of a fuel cell system including an integrated chemical combustion heater integrated with a fuel reformer system according to the present invention.

### DESCRIPTION OF THE PREFERRED EMBODIMENTS

The chemical combustion heater of the present invention is anticipated for use in a fuel processor, or more specifically a fuel reformer, that includes a vaporization zone and a reaction zone including a reforming catalyst. The chemical combustion heater is thermally coupled to the vaporization and reaction zones of the fuel reformer. The chemical combustion heater is formed utilizing multilayer ceramic technology in which thin ceramic layers are assembled then sintered to provide for miniature dimensions in which the encapsulated combustion catalyst converts or air oxidizes the inlet fuel into water vapor, carbon dioxide and nitrogen (from the air) gases and heat.

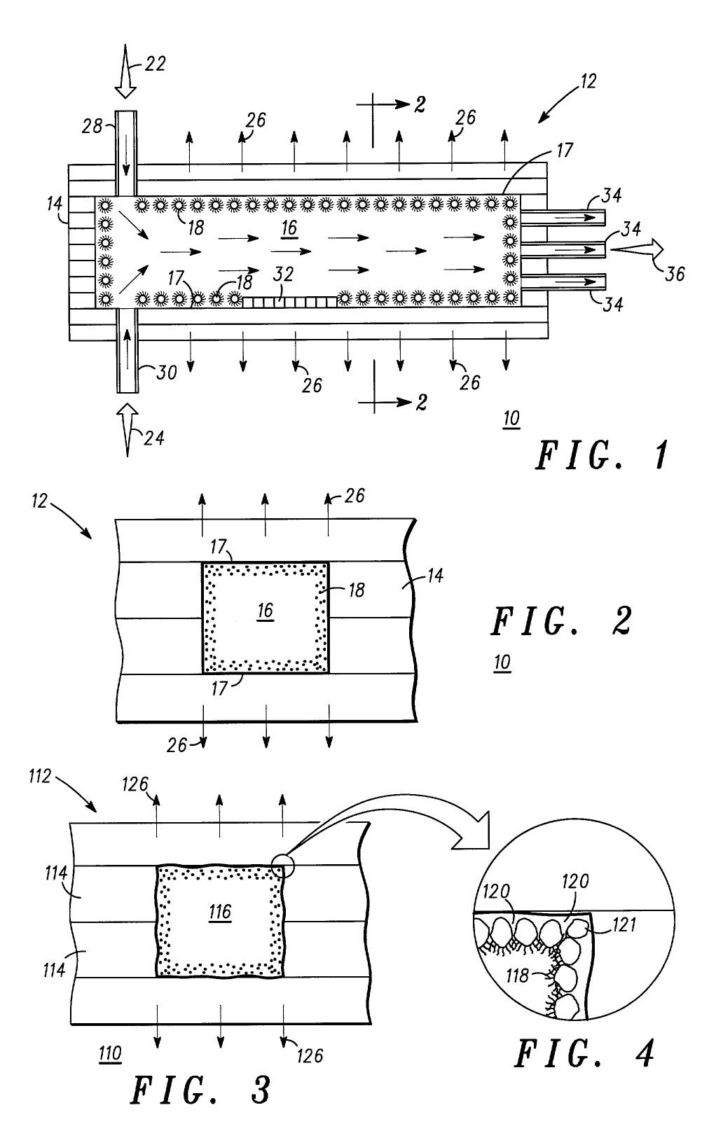

Turning now to the drawings, and in particular FIG. 1, illustrated in simplified sectional view is a first embodiment of a chemical combustion heater 10 according to the present invention. Illustrated in FIG. 2 is a sectional view taken along line 2-2 of FIG. 1. Chemical combustion heater 10 is formed using multilayer ceramic technology, and is thus comprised of a ceramic material 12. More particularly, chemical combustion heater 10 is comprised of a plurality of ceramic layers 14 that undergo firing, and are thus sintered together during processing, prior to the introduction of a catalyst material (described presently), to form heater 10 and a ceramic cavity 16. Ceramic cavity 16 provides for the control of flow of fuel and air (discussed presently). Ceramic cavity 16 is further described as having a geometric surface area as evidenced by a plurality of surfaces 17 that define ceramic cavity 16. A catalyst material 18 is formed in combination with ceramic cavity 16. More particularly, catalyst material 18 in this particular embodiment is described as an impregnated catalyst formed on plurality of surfaces 17 defining ceramic cavity 16. Catalyst 18 is characterized as providing for complete air oxidation of an input fuel 22 and the generation of heat 26 in proportion to the feed rate of input fuel 22 and air 24. Catalyst 18 in the preferred embodiments is formed of a high surface area platinum (Pt). Alternatively, catalyst 18 is formed of an active metal such as silver (Ag), palladium (Pd), nickel (Ni), or the like. Various active metal oxides, active metal oxychlorides and active metal oxynitrides can act as alternative catalyst materials to noble metals like Pt as combustion catalysts and as performance enhancing supports for combustion catalyst materials. These mixed metal ionic species have compositions of positive metal ions, like ferrous ion, Fe⁺² or ferric ion, Fe⁺³, and negative ions, like oxide ion, 0⁻², or chloride, Cl⁻¹, or nitride, N⁻³.

Active transition metal oxides such as a manganese oxide (MnO, MnO₄, MnO₆), cobalt oxide (Co₂O₃), molybdenum oxide (MoO₂, Mo₂O₃, or Mo₂O₅), chrome oxide (Cr₂O₃), can be defined using iron oxide (FeₓO_{y}) as an example, where a family of active metal oxides (MₓO_{y}) with M is any transition metal, preferably from Groups VIA, VIIA, and VIIIA, consisting of active metal oxides with x=1 and y=1 (e.g., FeO) or x=2 and y=3 (e.g., Fe₂O₃), and admixtures thereof (e.g., Fe₃O₄ forms by mixing the FeO and Fe₂O₃ in a 1 to 1 ratio). In general, these active metal oxides can be expressed as M_{x+x′}O_{y+y′}:

e.g., for FeO, FeₓO_{y} with x=0 to 1 and y=x;

and for Fe₂O₃ we have x′=0 to 2 and y′=3/2x′ y′=y(3/2),

and then admixtures thereof can be formulated as Fe_{x+x′}O_{y+y′}.

e.g., for the 1 to 1 iron oxide admixture, Fe₃O₄;

we have x=1, x′=2 and y=1 and y′=3.

Using iron oxide (FeₓO_{y}) as an example, a family of active metal oxychlorides can be defined and expressed as, M_{x+x′}O_{y+y′}Cl_{z+z′}, where M is any transition metal, preferably from Groups VIA, VIIA, and VIIIA of the Periodic Table, and x=1 or 2, y=1 or 3, and z=0 to 6.

e.g., for FeO_{y-z}Cl_{z}, x=1, y=x−z/2 and z=0 to 2x;

for Fe_{x′}O_{y′}Cl_{z′}, x′=1 or 2 and y′=(3/2)*x′−z′/2 and z′=0 to 3x

e.g., for Fe₂O₂Cl₂ x′=2; z′=1x; then y′=(3/2)*2−2/2=2

and admixtures there of, Fe_{x+x′}O_{y+y′}Cl_{z+z′}

and for Fe₃O₃Cl₂, x=1, x′=2; z=2x=2; so y=x−z/2=0; z′=0 so y′=3/2*x′−z′=3

By analogy, similar formulations can be made for active metal oxynitrides and their mixtures with chloride and all admixtures.

If a cation such as Pt(IV) is substituted for iron in the iron oxides and analogues examples, then substitution in iron oxide example would yield an active mixed metal oxide, in general this can be formulated as PtₐFeₓO_{y} where a=0 to 1 and x=0 to 1 and y=x+2a. For the active mixed metal oxide case where a=¼ and x=½, then y=1, would describe Pt_{1/4}Fe_{1/2}O or PtFe₂O₄. Mixed active metal oxychloride and oxynitrides can be formulated by substitution of this formulation into proper generator expressions in analogy to those above for iron species.

The principle benefit of having the positively charged metal ion with various oxide, chloride and nitride negative ions and mixed-negative-ions is this gives a metal for tailoring the metal ion for catalyzing specific chemical reactions and yet promote stability of chemically active metal ions catalysts. In general other metals and combinations of metals with anions, e.g., like ZrOCl₂, AlOCl, and mixed metal oxychlorides and oxynitrides, etc., can be useful as combustion catalysts and supports for combustion catalysts, and it should additionally be understood that anticipated is a catalyst 18 formed of any combination of active metals, active metal oxides, active metal oxychlorides, and active metal oxynitrides.

During operation, chemical combustion heater 10 is characterized as giving off heat 26 (as noted by directional arrows) in proportion to the feed rate of input fuel 22 in the presence of sufficient or excess air 24. Accordingly, an input fuel inlet 28 is formed to provide for the inlet of input fuel 22 into ceramic cavity 16. Input fuel 22 in a preferred embodiment is hydrogen. Dependent upon use, alternate fuel sources, such as neat methanol, any admixtures of methanol and water, or methanol, water and hydrogen, and even mixtures of these previously mentioned fuels with any other hydrocarbon fuels, like methane, propane, butane, etc., can be used for input fuel 22. In addition, an air inlet 30 provides for the inlet of air 24 (comprised of mainly 20% oxygen and 80% nitrogen) into ceramic cavity 16. This input combination of input fuel 22 and air 24 moves through ceramic cavity 16, and comes in contact with catalyst 18, thereby generating heat 26 as indicated by directional arrows. It should be understood that anticipated by this disclosure is alternatively a single inlet which serves as a combination pre-mixed fuel/air inlet.

Additionally included as a part of device 10 is at least one temperature sensor 32. Temperature sensor 32 is provided to permit feedback control of the feed rate of fuel 22 and air 24 into ceramic cavity 16. Dependent upon desired temperature being reached and modification of that temperature, the feedback control provides for adjustment of the portions and proportion of fuel 22 and air 24 that enters ceramic cavity 16.

During operation of chemical combustion heater 10, catalyst 18 provides for the complete air oxidation of input fuel 22 with air 24. This oxidation provides for the generation of heat 26 which is dissipated through ceramic structure 12. There is provided an outlet 34 which allows for the output of any uncombusted fuel 22 and air 24, and any additional combustion by-product 36 such as carbon dioxide (CO₂), water (H₂O), nitrogen (N₂) or lost heat, generated within ceramic cavity 16. Accordingly, chemical combustion heater 10 is described as generating heat that is dissipated from ceramic cavity 16 through ceramic structure 12.

Referring now to FIG. 3, illustrated in simplified sectional view is a second embodiment of a chemical combustion heater according to the present invention, referenced 110. Chemical combustion heater 110 is formed using multilayer ceramic technology, and is thus comprised of a ceramic material 112. Chemical combustion heater 110 includes a ceramic cavity 116 formed by a plurality of ceramic layers 114. Firing of the plurality of ceramic layer 114 provides for the sintering of the plurality of layers 114, thereby defining ceramic cavity 116. Ceramic cavity 116 is defined by a plurality of surfaces 117. Surfaces 117 in this particular embodiment have undergone a surface treatment step, such as acid etching, prior to the sintering of layers 114, to expose the outer surfaces of a plurality of ceramic particles 121 that comprise ceramic material 112. A catalyst material 118 is next introduced into ceramic cavity 116 and formed in combination with ceramic particles 121 that comprise ceramic material 112 within ceramic layers 114 making up the plurality of surfaces 117 defining ceramic cavity 116.

Referring to FIG. 4, illustrated is an enlarged portion of a surface 117 indicated in FIG. 3, in which shown is surface 117 that has been treated with an initial acid etch step. It should be understood that ceramic material 112 is comprised of the plurality of ceramic particles 121 defining therebetween a plurality of voids 120. More specifically, by treating surfaces 117 with an initial acid etch step, the plurality of voids 120 formed between ceramic particles 121 are exposed, thereby providing for an increased surface area within ceramic cavity 116. The exposing of particles 121 and thus voids 120 provides for a more efficient device 110 in that a greater real surface area than the geometric area of ceramic cavity 116 is exposed. Furthermore, this exposing of particles 121 and voids 120 to provide for a greater real surface area provides for maximum utilization of catalyst 118 and maximum optimization of the extent of conversion of the combustion of a fuel 122 (not shown) and an oxidant air 124 (not shown). The treatment of surfaces 117 provides for a more efficient and cost effective device 110 in that the exposing of voids 120 provides for (i) enhanced dispersion and therefore utilization of catalyst 118; (ii) enhanced catalytic activity for the combustion process; and (iii) enhanced stability of catalyst 118, that is activity of the catalyst 118 in time. An increased surface area of the catalyst per unit of mass of catalyst 118 results when catalyst 118 is dispersed by depositing catalyst 118 onto the pretreated surfaces 117 of ceramic cavity 116 and thus within voids 120. Typically this high catalyst 118 surface area results by dispersing a mass, a, of catalyst 118 by depositing a negligible volume of catalyst 118 material as a thin shell onto the surfaces 117 of ceramic cavity 116 with a mass, b, and of a volume, x. Catalyst 118 and ceramic material 112 composite essentially has a volume, x, which is virtually the same as the geometric volume, of ceramic cavity 116 only. The composite volume of catalyst 118 and ceramic material 112 behaves like a volume, x. A mass c, of catalyst 118 in the composite volume would be the volume, x, times the density of the catalyst 118. A mass, a, for catalyst 118 filling the whole volume, x, would be much greater than catalyst 118 mass, c. The enhanced dispersion of catalyst 118 would be proportional to the factor, c/a, which is the equivalent mass of pure catalyst 118 filling the whole volume, x, divided by the mass, a, of the catalyst 118 deposited on the surface of a volume, x, of the ceramic material 112. The factor c/a is a factor for calculating the beneficial cost savings per gram of catalyst 118 when using a catalyst 118 on a support compared to when using a solid catalyst 118 particle.

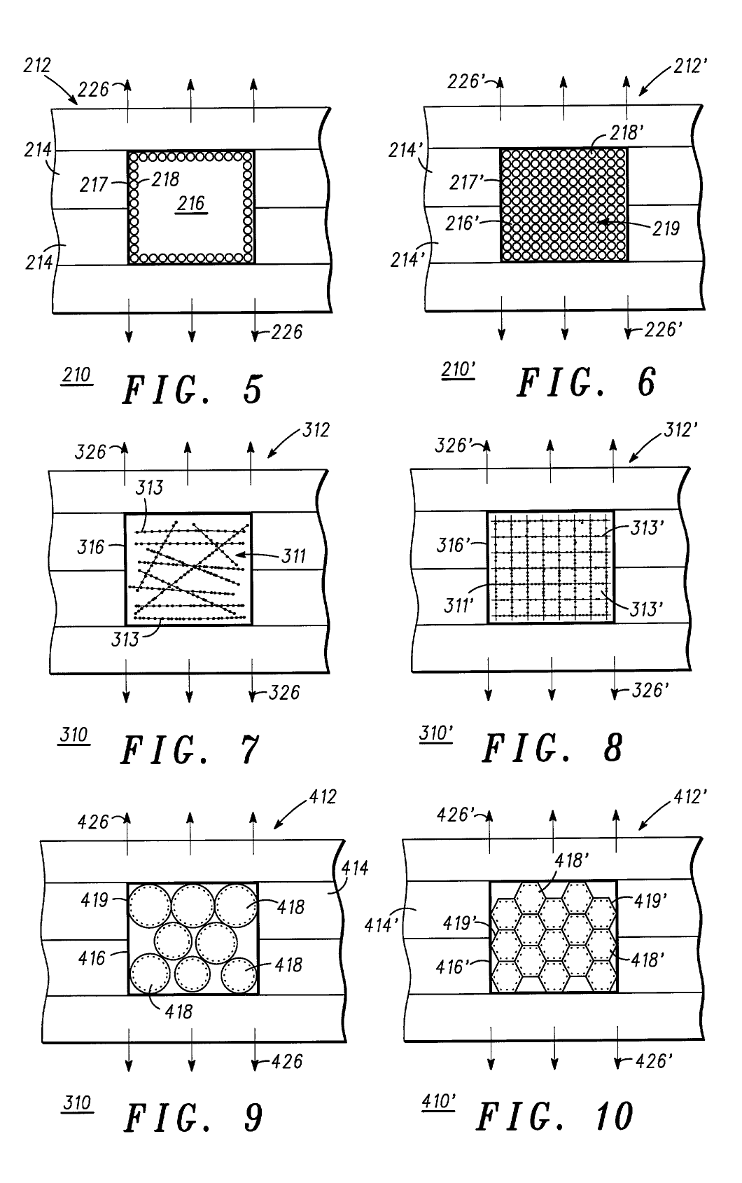

Referring now to FIGS. 5 and 6, illustrated in simplified sectional views are additional embodiments of the chemical combustion heater according to the present invention. More specifically, Illustrated in FIG. 5 is a sectional view of a chemical combustion heater 210, generally similar to heater 10 as illustrated in FIG. 2, except in this particular embodiment, a catalyst 218 is formed of a standard supported catalyst that is adhered to surfaces 217 of ceramic cavity 216. More particularly, in this embodiment, catalyst 218 is formed of a catalyst powder or catalyst ink, that is introduced into cavity 216 subsequent to the firing of the plurality of layers of ceramic material 214, and adheres to surfaces 217 of ceramic cavity 216. Illustrated in FIG. 6 is a similar embodiment of a chemical combustion heater referenced 210′ in which standard supported catalyst 218′ is provided subsequent to the firing of plurality of ceramic layers 214′ so as to fill the space defined within ceramic cavity 216′, thereby forming a packed powder catalyst bed 219. It should be noted that all components of FIG. 6 that are similar to the components illustrated in FIG. 5, are designated with similar numbers, having a prime added to indicate the different embodiment.

Similar to the previously described catalyst of the prior embodiments, catalyst 218/218′ is characterized as providing for complete air oxidation of an input fuel and the generation of heat 226/226′ in proportion to the feed rate of the input fuel and air. Catalyst 218/218′ in this embodiment is comprised of any catalyst material similar to those previously described with respect to the prior embodiments.

During operation, chemical combustion heater 210/210′ is characterized as giving off heat (as noted by directional arrows 226/226′) in the same manner as described with respect to the previous embodiments of FIGS. 1, 2, and 3. Heater 210/210′ generates in proportion to the feed rate of an input fuel in the presence of a sufficient or excess air. Accordingly, similar to the embodiment illustrated in FIG. 1, an input fuel inlet similar to fuel inlet 28 of FIG. 1, is formed to provide for the inlet of an input fuel into ceramic cavity 216/216′. In addition, an air inlet similar to air inlet 30 of FIG. 1, provides for the inlet of air (comprised of mainly 20% oxygen and 80% nitrogen) into ceramic cavity 216/216′. This input combination of input fuel and air moves through ceramic cavity 216/216′, and comes in contact with catalyst 218/218′, thereby generating heat 226/226′ as indicated by the directional arrows.

Additionally included as a part of device 210/210′, and similar to the embodiment illustrated in FIG. 1, is at least one temperature sensor (not shown). The temperature sensor is provided to permit feedback control of the feed rate of fuel and air into ceramic cavity 216/216′. Dependent upon desired temperature being reached and modification of that temperature, the feedback control provides for adjustment of the portions and proportion of fuel and air that enters ceramic cavity 216/216′.

During operation of chemical combustion heater 210/210′, catalyst 218/218′ provides for the complete air oxidation of input fuel with air. This oxidation provides for the generation of heat 226/226′ which is dissipated through ceramic structure 212/212′. There is provided an outlet, generally similar to outlet 34 of FIG. 1, which allows for the output of any uncombusted fuel and air, and any additional combustion by-product such as carbon dioxide (CO₂), water (H₂O), nitrogen (N₂) or lost heat, generated within ceramic cavity 216/216′. Accordingly, chemical combustion heater 210/210′ is described as generating heat that is dissipated from ceramic cavity 216/216′ through ceramic structure 212/212′.

Referring now to FIGS. 7 and 8, illustrated in simplified sectional view are additional embodiments of the chemical combustion heater according to the present invention. More specifically, illustrated in FIG. 7 is a sectional view of a chemical combustion heater 310, generally similar to sectional view of heater 10 as illustrated in FIG. 2, except in this particular embodiment, a ceramic felt 311 is included within a ceramic cavity 316. Ceramic felt 311 in this particular embodiment is formed of a plurality of non-woven ceramic fibers 313 that provide for an increase in the real surface area of ceramic cavity 316. A catalyst 318 is introduced into ceramic cavity 316 and is formed on ceramic felt 311, and more particularly formed on the individual ceramic fibers 313 that comprise ceramic felt 311. Illustrated in FIG. 8 is a similar embodiment of a chemical combustion heater referenced 310′ in which a ceramic felt 311′ is formed of a plurality of woven ceramic fibers 313′ that provide for an increase in the real surface area of ceramic cavity 316. It should be noted that all components of FIG. 8 that are similar to the components illustrated in FIG. 7, are designated with similar numbers, having a prime added to indicate the different embodiment.

The embodiments as illustrated in FIGS. 7 and 8 operate to generate heat 326/326′ in the same manner as the previous embodiments. More specifically, included is a fuel inlet and air inlet into ceramic cavity 316/316′ thereby providing for complete air oxidation of the input fuel. This oxidation provides for the generation of heat 326/326′ which is dissipated through ceramic structure 312/312′. It is anticipated by this disclosure the use of ceramic felt 311/311′ as an addition to any of the embodiments illustrated in FIGS. 1-5 to increase the real surface area, and thus provide for a more efficient device.

Referring now to FIGS. 9 and 10, illustrated in simplified sectional views are further embodiments of the chemical combustion heater according to the present invention. More particularly, illustrated in FIGS. 9 and 10 is a ceramic cavity 416/416′ formed therein a plurality of ceramic layers 414/414′. Chemical combustion heater 410/410′ is formed using multilayer ceramic technology, and is thus comprised of a ceramic material 412/412′. More particularly, combustion heater 410/410′ is comprised of a plurality of ceramic layers 414/414′ that are sintered together during processing to form heater 410/410′ and a ceramic cavity 416/416′. In this particular embodiment, a plurality of channels 419/419′ are formed within ceramic cavity 416/416′. It should be understood that any number of channels 419/419′ are anticipated by this disclosure and it should not be limited to the number illustrated in the drawings. As illustrated in FIG. 9, channels 419 are formed of a plurality of tubular structures that are bundled and positioned therein cavity 416. (Are they positioned before or after the sintering of the ceramic layers). It is disclosed in a preferred embodiment, that channels 419 are formed of a ceramic material, but it is anticipated by this disclosure the inclusion of a plurality of channels 419 formed of glass, metal, or the like. As illustrated in FIG. 10, channels 419′ are formed in a honeycomb formation. Similar to channels 419, channels 419′ are formed of a ceramic material, a glass, a metal, or the like. Channels 419/419′ provide for an increase in real surface area for the placement of catalyst 418/418′. More specifically, channels 419/419′ provide for an increased surface area within ceramic cavity 416/416′. This provision of more surface area provides for a more efficient device 410/410′ in that a greater real surface area than the geometric area of ceramic cavity 416/416′ is exposed thereby providing for maximum utilization of a catalyst 418/418′ positioned within channels 419/419′ and maximum optimization of the extent of conversion of the combustion of an input fuel and an input oxidant air.

Catalyst material 418/418′ is formed within ceramic cavity 416/416′. More particularly, catalyst material 418/418′ in this particular embodiment is described as an impregnated catalyst formed within channels 419/419′. Similar to the previously described catalyst of the prior embodiments, catalyst 418/418′ is characterized as providing for complete air oxidation of an input fuel and the generation of heat 426/426′ in proportion to the feed rate of the input fuel and air. Catalyst 418/418′ in this embodiment is comprised of any catalyst material similar to those previously described with respect to the prior embodiments.

Additionally included as a part of device 410/410′ is at least one temperature sensor, similar to temperature sensor 32 of FIG. 1. The temperature sensor is provided to permit feedback control of the feed rate of input fuel and air into channels 419/419′. Dependent upon desired temperature being reached and modification of that temperature, the feedback control provides for adjustment of the portions and proportion of input fuel and air that enters channels 419/419′.

Similar to the previous embodiments, during operation of chemical combustion heater 410/410′, catalyst 418/418′ formed within channels 419/419′ provides for the complete air oxidation of the input fuel with air. This oxidation provides for the generation of heat 426/426′ which is dissipated through ceramic structure 412/412′.

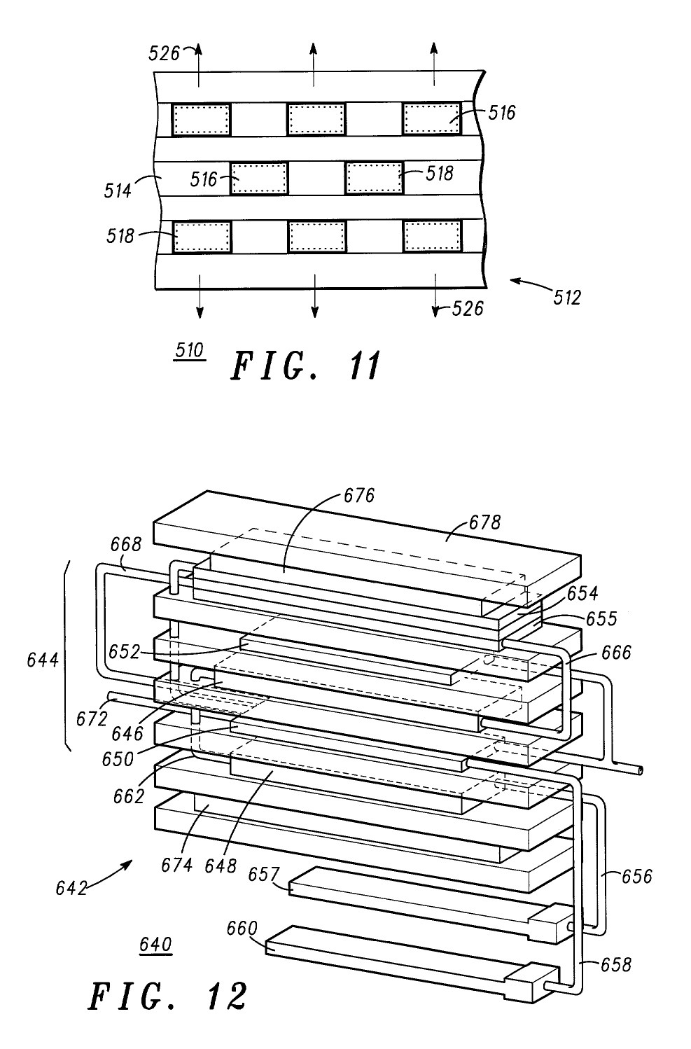

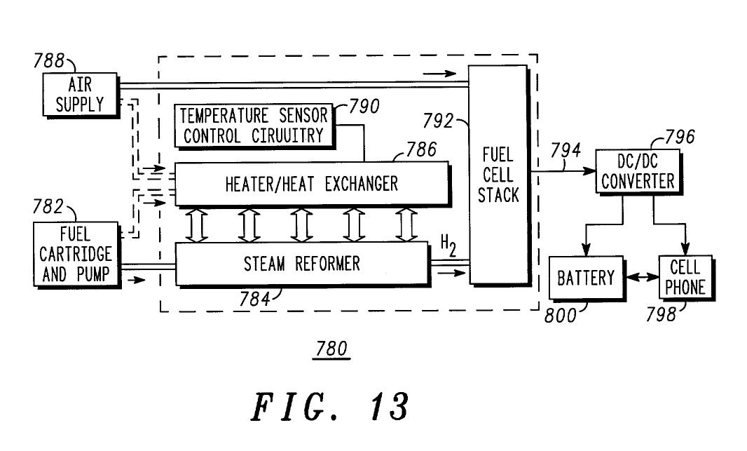

Referring now to FIG. 11, illustrated in simplified sectional view is a further embodiment of the chemical combustion heater according to the present invention. More particularly, illustrated in FIG. 11 is a chemical combustion heater 510, including a plurality of ceramic cavities 516 formed therein a plurality of ceramic layers 514. Similar to the previous disclosed embodiments, chemical combustion heater 510 is formed using multilayer ceramic technology, and is thus comprised of a ceramic material 512. More particularly, chemical combustion heater 510 is comprised of a plurality of ceramic layers 514 that are sintered together during processing to form heater 510 and more specifically, the plurality of ceramic cavities 516. Ceramic cavities 516 provide for the control of flow of fuel and air. Ceramic cavities 516 each have a geometric surface area defined by the individual cavity structures. Ceramic cavities 516 are typically formed dimensionally smaller than when a single cavity is utilized to form the chemical combustion heater, such as with single ceramic cavity 16 of FIG. 1. It should be understood that any number of ceramic cavities 516 formed in ceramic structure 512 are anticipated by this disclosure and it should not be limited to the number illustrated in the drawings. Additionally, it should be understood that anticipated by this disclosure is the fabrication of device 510 to include ceramic cavities 516 formed according to any of the previously disclosed embodiments for including catalyst 518, subsequent to the sintering of layer of the plurality of ceramic layers 514.

Referring now to FIG. 12, illustrated is a fuel processor 640 according to the present invention, including a plurality of microfluidic channels and a chemical combustion heater, which could be fabricated according to any of the previously disclosed embodiments for the chemical combustion heater of the present invention. Fuel processor system 640 is comprised of a three-dimensional multilayer ceramic structure 642. Ceramic structure 642 is formed utilizing multilayer laminate ceramic technology. Structure 642 is typically formed in component parts which are then sintered in such a way as to provide for a monolithic structure. Ceramic structure 642 has defined therein a fuel processor, generally referenced 644. Fuel processor 644 includes a reaction zone, or fuel reformer, 646, a vaporization chamber, or vaporization zone, 648, and an integrated chemical combustion heater, 650, generally similar to chemical combustion heater 10 of FIG. 1. It should be understood that chemical combustion heater 650 can be formed according to any of the previously disclosed embodiments herein. In addition, included as a part of fuel processor 644, is a waste heat recovery zone 652, and a fuel cell stack 654.

Ceramic structure 642 further includes at least one fuel inlet ceramic cavity 656 in fluidic communication with fuel vaporizer 648 and a liquid fuel source comprised of a combination solution of methanol and water 657. At least one fuel input inlet 658 is formed to provide for fluidic communication between a fuel source 660, and combustion heater 650. It should be understood that anticipated by this disclosure is a single fuel tank, that is in fluidic communication with both fuel vaporizer 648 and chemical combustion heater 650.

During operation of fuel processor 640, fuel 657 enters fuel vaporizer 648 through a ceramic cavity 656 and is vaporized with the vaporous methanol and vaporous water (steam) exiting vaporizer 648 through output 662 which is in fluidic communication with fuel reformer 646. Fuel inlet 658 provides for the input of fuel to chemical combustion heater 650. An air inlet 664 provides for the input of air to chemical combustion heater 650 and to waste heat recovery zone 652. Chemical combustion heater 650 allows for complete air oxidation of fuel input 658 and subsequent dissipation of heat through structure 642 and more specifically, to fuel reformer 646 and fuel vaporizer 648.

As previously stated, fuel 657 entering fuel vaporizer 648 is vaporized and the resultant vaporous methanol and water enters the reaction zone, or more specifically fuel reformer, 646 where it is converted to hydrogen enriched gas. There is provided a hydrogen enriched gas outlet channel 666 from fuel reformer 646 that is in fluidic communication with an inlet to fuel cell stack 654, and more particularly to a fuel cell anode 655. Fuel cell anode 655 provides for depletion of hydrogen from the hydrogen enriched gas mixture. This hydrogen depleted hydrogen enriched gas mixture exits fuel cell stack 654, and more particularly anode 655 through a fluidic communication 668 and is input to an inlet of chemical combustion heater 650. Chemical combustion heater 650 also oxidizes portions of this gas mixture to generate heat and provides for any uncombusted materials present, such as remaining hydrogen and carbon monoxide, to undergo air oxidation to water and carbon dioxide, and these as well nitrogen from air, are then vented through an outlet 672 away from structure 642 into the atmosphere.

During operation, heat is efficiently transferred from the central aspect of the device, more particularly from chemical combustion heater 650, to the fuel reformer 646 and fuel vaporizer, or vaporization zone 648 using thermal conductive channels (discussed presently). As previously described, output from fuel vaporizer zone 648 travels via channel 662 to the reaction zone, or to fuel reformer 646, and then through hydrogen enriched gas outlet channel 666 to fuel cell stack 654. Spent gases from the fuel cell stack 654 are directed through a waste heat recovery zone 652 to capture the heat from the spent gases.

Efficient thermal insulators 674 and 676 are positioned around fuel processor 644, under fuel vaporizer zone 648, and above fuel cell stack 654 to keep outer temperatures low for packaging and also to keep heat generated within the device localized to the fuel processor 644. As illustrated in FIG. 12, in this particular example, high temperature fuel cell stack 654 is integrated with fuel processor 644. This particular fuel cell design allows for the operation of the fuel cell stack at a temperature ranging from 140-230° C., with a preferred temperature of 150° C. Fuel vaporizer zone 648 operates at a temperature ranging from 120-230° C., with a preferred temperature of 180° C. and fuel reformer 646 operates at a temperature ranging from 180-300° C., with a preferred temperature of 230° C. Additionally, in this particular embodiment of fuel processor system 640, included is a top cap 678.

It should be understood that alternative embodiments encompassing: (i) alternative fuel delivery means, either passive or active pumping; (ii) fuel vaporizer, reaction zone, and chemical heater positions; and (iii) a fuel reformer device without an integrated fuel cell, are anticipated by this disclosure. In particular, anticipated is an embodiment in which only a single fuel supply, namely methanol, or methanol and water, is anticipated. This use of a single methanol, or methanol and water solution would enable the fabrication of a simpler design, without any need for the device to incorporate two fuel tanks. Although it is understood that pure methanol is more efficient and preferred with respect to the chemical combustion heater, a 1 mole water and 1 mole methanol solution will also work, but is not deemed literally as operationally efficient. Further, a heater using the water and methanol solution is suitable for practical applications, and would permit a simple common fuel reservoir for feeding the chemical combustion heater 650 and fuel reformer 646.

Next, anticipated are variations on the actual design of system 640 and more particularly to the actual location of the fuel vaporizer zone 648, fuel reformer 646 and chemical combustion heater 650. In one particular alternative embodiment, it is anticipated that fuel reformer 646 surrounds the chemical combustion heater 650 on both sides (top and bottom). In yet another alternative embodiment, it is anticipated that fuel reformer 646 can be positioned below chemical combustion heater 650 and the fuel vaporizer zone 648 on top of the chemical combustion heater 650.

Finally, it is anticipated by this disclosure that although illustrated in FIG. 12 is the integration of fuel cell stack 654 with processor 644, a design in which a fuel cell is not integrated with fuel processor 644 is additionally anticipated. Further information on a reformed hydrogen fuel system device of this type can be found in U.S. Patent application, bearing Ser. No. 09/649,528, entitled “HYDROGEN GENERATOR UTILIZING CERAMIC TECHNOLOGY”, filed Aug. 28, 2000, assigned to the same assignee and incorporated herein by this reference. When fuel cell stack 654 is integrated with fuel reformer 646, advantage can be taken of the heat of the substrate to operate high temperature fuel cell stack 654. For high power applications, it is convenient to design a separate fuel cell stack 654 and a fuel processor unit 644 and couple them to supply the hydrogen enriched fuel for the fuel cell. In such instances, when a fuel cell stack is not integrated with the fuel processor, and the fuel processor is designed as a stand alone device, external connection can be made to connect the stand alone fuel processor to a traditional fuel cell stack for higher power applications.

Illustrated in FIG. 13 in a simplified flow chart diagram 780, is the fuel processor system 640 of FIG. 12, including a multilayer ceramic structure, a fuel processor, a fuel cell stack, insulators, and fuels, similar to previously described multilayer ceramic structure 742 having a fuel processor 744, fuel cell stack 754, insulators 774 and 776, and fuels 754 and 760 of device 740. As illustrated, a fuel cartridge, generally including an optional pump mechanism 782 supplies water and methanol into a steam reformer 784, generally similar to fuel reformer 646 of FIG. 12 and a chemical combustion heater 786, generally similar to chemical combustion heater 650 of FIG. 12. An air supply 788 provides for the supplying of air to heater 786 and a fuel cell stack 792. Heater 786 is monitored by a temperature sensor, including control circuitry, 790 thereby providing for steam reformer 784 to operate at a temperature of approximately 230° C. Operation of steam reformer 784 at this temperature allows for the reforming of input fuel 782 into a reformed gas mixture, generally referred to as the hydrogen enriched gas. More particularly, in the presence of a catalyst, such as copper oxide, zinc oxide, or copper zinc oxide, the fuel solution 782 is reformed into hydrogen, carbon dioxide, and some carbon monoxide. Steam reformer 784 operates in conjunction with an optional carbon monoxide cleanup (not shown), that in the presence of a preferential oxidation catalyst and air (or O₂), reforms a large percentage of the present carbon monoxide into carbon dioxide. This reformed gas mixture supplies fuel through a fuel output to fuel cell 792, generally similar to fuel cell stack 654 of FIG. 12. Fuel cell 792 generates electricity 794 and is illustrated in this particular example as providing energy to a DC-DC converter 796, thereby supplying power to a cell phone 798 and/or battery 800.

Accordingly, described is a chemical combustion heater comprised of a plurality of ceramic material layers, including at least one ceramic cavity formed therein and defining a geometric surface area. Subsequent to a firing step, in which the plurality of ceramic layers are sintered together, a catalyst material is introduced and formed in combination with the at least one ceramic cavity, either positioned on a surface of the at least one ceramic cavity, entrapped within voids formed between a plurality of ceramic particles which form the at least one ceramic cavity, or formed within a plurality of channels formed inside the at least one ceramic cavity. The catalyst is characterized as providing for complete air oxidation of an input fuel and the generation of heat. The chemical combustion heater generates heat and is integrated into a fuel processor including a ceramic carrier defining a reaction zone including a catalyst, thereby providing heat to the reaction zone. An inlet channel is supplied for input of the liquid fuel to the fuel processor and an outlet channel is supplied for the output of hydrogen enriched or reformed gas mixture. The fuel processor device including the chemical combustion heater is formed as a monolithically integrated structure, generally comprised of a plurality of thin ceramic layers assembled and then sintered in such a way as to provide for the closed heating zones in which the chemical combustion heater provides for the maintenance of a specific temperature within the device allowing for the encapsulated catalyst to reform the inlet fuel into mostly hydrogen gas suitable for use with a fuel cell stack.

While we have shown and described specific embodiments of the present invention, further modifications and improvements will occur to those skilled in the art. We desire it to be understood, therefore, that this invention is not limited to the particular forms shown and we intend in the appended claims to cover all modifications that do not depart from the spirit and scope of this invention.

What is claimed is:

1. A chemical combustion heater comprising:
a fired ceramic carrier structure defining at least one ceramic cavity, the at least one ceramic cavity having a geometric surface area; and
a catalyst material formed in combination within the at least one ceramic cavity, the catalyst characterized as providing for complete air oxidation of an input fuel and the generation of heat.

2. A chemical combustion heater as claimed in claim 1 wherein the ceramic structure is a monolithic three-dimensional multilayer ceramic structure.

3. A chemical combustion heater as claimed in claim 2 wherein the monolithic three-dimensional multilayer ceramic structure is comprised of a plurality of thin ceramic layers assembled and sintered to provide for a closed heating zone.

4. A chemical combustion heater as claimed in claim 3 wherein the catalyst is chosen from the group consisting of: an active metal, an active metal oxide, a metal oxynitride, a metal oxychloride, a combination of a plurality of active metals, and a combination of a plurality of active metal oxides.

5. A chemical combustion heater as claimed in claim 4 wherein the catalyst is formed on a plurality of surfaces defined by the ceramic cavity.

6. A chemical combustion heater as claimed in claim 5 wherein the plurality of surfaces are formed as a plurality of acid etched surfaces, the acid etch surfaces defining a plurality of ceramic particles having a plurality of voids formed therebetween, the catalyst being entrapped within the plurality of voids of the ceramic material, and in contact with a surface of the ceramic particles.

7. A chemical combustion heater as claimed in claim 4 wherein the catalyst is a standard supported catalyst formed on a plurality of surfaces defined by the ceramic cavity.

8. A chemical combustion heater as claimed in claim 7 wherein the catalyst is a standard supported catalyst formed as a packed powder bed within the ceramic cavity.

9. A chemical combustion heater as claimed in claim 4 further including a porous ceramic felt positioned within the ceramic cavity and having entrapped therein the catalyst.

10. A chemical combustion heater as claimed in claim 9 wherein the porous ceramic felt is defined by a plurality of woven fibers.

11. A chemical combustion heater as claimed in claim 9 wherein the porous ceramic felt is defined by a plurality of non-woven fibers.

12. A chemical combustion heater as claimed in claim 4 wherein a plurality of ceramic cavities are defined by the ceramic carrier structures.

13. A chemical combustion heater as claimed in claim 4 further including a plurality of ceramic structures formed within the ceramic cavity and defining a plurality of channels, wherein the catalyst is formed within each of the plurality of channels.

14. A chemical combustion heater as claimed in claim 1 further including at least one temperature sensor for providing feedback control of a feed rate of the input fuel and air.

15. A chemical combustion heater comprising:
a monolithic three-dimensional multilayer ceramic structure, the monolithic three-dimensional multilayer ceramic structure comprised of a plurality of thin ceramic layers assembled and sintered to provide for at least one ceramic cavity having a geometric surface area, and thereby defining a closed heating zone; and
a catalyst material formed within with the at least one ceramic cavity, the catalyst characterized as providing for complete air oxidation of a fuel and the generation of heat.

16. A chemical combustion heater as claimed in claim 15 further including a fuel input in communication with the catalyst thereby providing for an inlet for the fuel, an air input in communication with fuel input and the catalyst thereby providing for an inlet for an oxidizing air, and an output in communication with the catalyst thereby providing for the output of uncombusted fuel and air.

17. A chemical combustion heater as claimed in claim 15 wherein the catalyst is chosen from the group consisting of: an active metal, an active metal oxide, a metal oxynitride, a metal oxychloride, a combination of a plurality of active metals, and a combination of a plurality of active metal oxides.

18. A chemical combustion heater as claimed in claim 15 wherein the catalyst is formed on a plurality of surfaces defining the at least one ceramic cavity.

19. A chemical combustion heater as claimed in claim 17 wherein the catalyst is a standard supported catalyst formed as a packed powder bed within the at least one ceramic cavity.

20. A chemical combustion heater as claimed in claim 17 wherein the plurality of surfaces are formed as a plurality of acid etched surfaces, the acid etch surfaces defining a plurality of ceramic particles having a plurality of voids formed therebetween, the catalyst being entrapped within the plurality of voids of the ceramic material, and on a surface of the ceramic particles

21. A chemical combustion heater as claimed in claim 15 further including a porous ceramic felt positioned within the at least one ceramic cavity and having entrapped therein the catalyst.

22. A chemical combustion heater as claimed in claim 21 wherein the porous ceramic felt is defined by a plurality of woven fibers.

23. A chemical combustion heater as claimed in claim 21 wherein the porous ceramic felt is defined by a plurality of non-woven fibers.

24. A chemical combustion heater as claimed in claim 17 wherein a plurality of ceramic cavities are defined by the ceramic carrier structures.

25. A chemical combustion heater as claimed in claim 17 further including a plurality of ceramic structures formed within the ceramic cavity and defining a plurality of channels, wherein the catalyst is formed within the plurality of channels.

26. A chemical combustion heater as claimed in claim 15 further including at least one temperature sensor for providing feedback control of a feed rate of the input fuel and air.

27. A method of forming a chemical combustion heater comprising the steps of:
providing a ceramic material;
defining therein the ceramic material, at least one ceramic cavity, the at least one ceramic cavity having a geometric surface area;
firing the ceramic material to form a ceramic carrier structure having the at least one ceramic cavity defined therein;
depositing a catalyst material within the at least one ceramic cavity, the catalyst characterized as providing for complete air oxidation of an input fuel and the generation of heat.

28. A method of forming a chemical combustion heater as claimed in claim 27 wherein the step of firing the ceramic material to form a ceramic carrier structure includes firing a plurality of thin ceramic layers to provide for a closed heating zone.

29. A method of forming a chemical combustion heater as claimed in claim 27 wherein the step of depositing a catalyst material within the at least one ceramic cavity includes the step of depositing a catalyst material chosen from the group consisting of: an active metal, an active metal oxide, a metal oxynitride, a metal oxychloride, a combination of a plurality of active metals, and a combination of a plurality of active metal oxides.

30. A method of forming a chemical combustion heater as claimed in claim 27 further including the steps of forming a fuel input in communication with the catalyst thereby providing for an inlet for the fuel, an air input in communication with fuel input and the catalyst thereby providing for an inlet for an oxidizing air, and an output in communication with the catalyst thereby providing for the output of uncombusted fuel and air.

31. A method of forming a chemical combustion heater as claimed in claim 27 wherein the step of depositing a catalyst material within the at least one ceramic cavity includes the step of depositing the catalyst on a plurality of surfaces defining the at least one ceramic cavity.

32. A method of forming a chemical combustion heater as claimed in claim 27 wherein the step of depositing a catalyst material within the at least one ceramic cavity includes the step of depositing a standard supported catalyst as a packed powder bed within the at least one ceramic cavity.

33. A method of forming a chemical combustion heater as claimed in claim 27 wherein the step of defining therein the ceramic material, at least one ceramic cavity includes the step of acid etching a plurality of surfaces defining the ceramic cavity, thereby forming a plurality of ceramic particles having a plurality of voids formed therebetween, and entrapping the catalyst within the plurality of voids of the ceramic material, and on a surface of the ceramic particles

34. A method of forming a chemical combustion heater as claimed in claim 27 further including the step of positioning a porous ceramic felt within the at least one ceramic cavity and entrapping therein the catalyst.

35. A method of forming a chemical combustion heater as claimed in claim 27 further including the step of forming a plurality of ceramic structures within the ceramic cavity thereby defining a plurality of channels, and depositing the catalyst within the plurality of channels.

36. A fuel processor comprising:
a thermally conductive ceramic carrier defining a fuel reformer, the fuel reformer including a reaction zone including a reforming catalyst and an integrated chemical combustion heater thermally coupled to the reaction zone, wherein the chemical combustion heater has defined therein a plurality of thin ceramic layers assembled and sintered to provide for at least one ceramic cavity having a geometric surface area and a catalyst material formed within the at least one ceramic cavity arranged to air oxidize an input fuel to produce heat;
an inlet channel for liquid fuel;
an outlet channel for hydrogen enriched gas; and
an integrated fuel cell, including an anode in microfluidic communication with the outlet channel.

37. A fuel processor and integrated fuel cell as claimed in claim 36 wherein the fuel reformer further includes a fuel vaporization zone.

38. A fuel processor as claimed in claim 37 wherein the chemical combustion heater further includes an air inlet for providing oxygen for the oxidation of the fuel and a fuel input inlet to provide fuel to the chemical combustion heater.

39. A fuel processor as claimed in claim 36 wherein the integrated chemical combustion heater provides heat to the fuel vaporization zone and reaction zone using the thermally conductive ceramic carrier.

40. A fuel processor as claimed in claim 36 wherein the integrated chemical combustion heater including a catalyst arranged to oxidize an input fuel to produce heat includes a catalyst chosen from the group consisting of: an active metal, an active metal oxide, a metal oxynitride, a metal oxychloride, a combination of a plurality of active metals, and a combination of a plurality of active metal oxides.

41. A fuel processor as claimed in claim 36 wherein the chemical combustion heater further includes a ceramic felt having the catalyst embedded therein.
